(19) United States
(12) Patent Application Publication
(10) Pub. No.: US 2013/0262573 A1
(43) Pub. Date: Oct. 3, 2013

(54) DYNAMIC COMMUNICATION NETWORKS INTEGRATED WITH COMMUNITY NETWORKING APPLICATIONS

(71) Applicants: Orlando McMaster, Weston, FL (US); Eustace P. Isidore, Austin, TX (US)

(72) Inventors: Orlando McMaster, Weston, FL (US); Eustace P. Isidore, Austin, TX (US)

(21) Appl. No.: 12/970,938

(22) Filed: Dec. 17, 2010

(51) Int. Cl. H04L 29/08

(52) U.S. Cl. CPC H04L 67/22
USPC 709/204

(57) ABSTRACT

A method, a system and a computer program product for enabling an individual to efficiently create dynamic communication networks to communicate with members that have particular interests and experience, according to a network contact profile. A dynamic network creation (DNC) utility executes on a data processing system and enables an individual to spontaneously create a dynamic network defined by one or more of: (a) location of members; (b) particular affiliation of members; (c) experience of members; (d) authenticated credentials; and (e) other characteristics. The DNC utility enables the user to create a network contact profile or import existing profile information from a particular social networking application to the DNC system application. The DNC system allows individuals to create a network that may comprise members identified by various network affiliations. Thus, the DNC utility enables cross platform communication. The DNC system uses a target communication mechanism to enable a user to initiate a communication with a particular individual or a group of individuals. The DNC employs dynamic and intelligent GPS/LPS to provide directions between individuals in an established network.

### PRIORITY

The present application claims priority from provisional application, Ser. No. 61/287,184, filed on Dec. 16, 2009.

### BACKGROUND

1. Technical Field

The present invention generally relates to communication networks and in particular to the creation of dynamic communication networks and social media.

2. Description of the Related Art

With millions of users/members, social networking websites provide members with the opportunity to communicate with other members of diverse interests and backgrounds. Many social networking sites utilize a friend feature and a network of friends to enable communication between members following an approval of friendships. In addition, individuals often form groups to communicate with members based on similar interests and experiences. Memberships to these groups are granted following one or more of: (a) a search for groups; (b) an initiation/request to join; (c) and accepted invitation; and (d) an approved request. However, the process of making friends, forming groups and the associated approval procedures take time and may not be useful to real-life situations in which fast/efficient systems for communication with other individuals are required.

### BRIEF SUMMARY

Disclosed are a method, a system and a computer program product for enabling an individual to efficiently create dynamic communication networks to communicate with members that have particular interests and experience, according to a network contact profile. A dynamic network creation (DNC) utility executes on a data processing system and enables an individual to spontaneously create a dynamic network defined by one or more of: (a) location of members; (b) particular affiliation of members; (c) experience of members; (d) authenticated credentials; and (e) other characteristics. The DNC utility enables the user to create a network contact profile or import existing profile information from a particular social networking application to the DNC system application. The DNC system allows individuals to create a network that may comprise members identified by various network affiliations. Thus, the DNC utility enables cross platform communication. The DNC utility/system uses a target communication mechanism to enable a user to initiate a communication with a particular individual or a group of individuals. The DNC utility employs dynamic and intelligent GPS/LPS to provide directions between individuals (i.e., to allow individuals to meet in person) connected in an established communication network.

As utilization of social media expands, the need for new and efficient ways to communicate significantly increases. The DNC utility/system provides instant/on-demand communication with diverse types of individuals. The DNC utility represents a paradigm shift that is based upon a system which allows individuals to save and utilize dynamic communication networks (i.e., network configurations) just as efficiently as telephone numbers are currently used.

The above as well as additional objectives, features, and advantages of the present invention will become apparent in the following detailed written description.

### BRIEF DESCRIPTION OF THE DRAWINGS

The invention itself, as well as advantages thereof, will best be understood by reference to the following detailed description of an illustrative embodiment when read in conjunction with the accompanying drawings, wherein:

FIG. 1 provides a block diagram representation of an example data processing system within which certain features of the invention may be practiced, according to one embodiment;

FIG. 2 illustrates an example network of servers collectively comprising a community networking application, a dynamic network creation application and a commercial business application, according to one embodiment;

FIG. 3 is a flow chart illustrating the process of creating dynamic communication networks, developing a network contact profile and utilizing the network contact profile to automatically provide individuals with access to dynamic communication networks, according to one embodiment; and

FIG. 4 is a flow chart illustrating the process of creating/utilizing a remote network contact profile to access dynamic communication networks, merging dynamic communication networks, and transferring messages/information between a dynamic communication network and an external application, according to one embodiment.

### DETAILED DESCRIPTION OF AN ILLUSTRATIVE EMBODIMENT

The illustrative embodiments provide a method, a system and a computer program product for enabling an individual to efficiently create dynamic communication networks to communicate with members that have particular interests and experience, according to a network contact profile. A dynamic network creation (DNC) utility executes on a data processing system and enables an individual to spontaneously create a dynamic network defined by one or more of: (a) location of members; (b) particular affiliation of members; (c) experience of members; (d) authenticated credentials; and (e) other characteristics. The DNC utility enables the user to create a network contact profile or import existing profile information from a particular social networking application to the DNC system application. The DNC utility/system allows individuals to create a network that may comprise members identified by various network affiliations. Thus, the DNC utility enables cross platform communication. The DNC utility/system uses a target communication mechanism to enable a user to initiate a communication with a particular individual or a group of individuals. The DNC employs dynamic and intelligent GPS/LPS to provide directions between individuals in an established network.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

Within the descriptions of the figures, similar elements are provided similar names and reference numerals as those of the previous figure(s). Where a later figure utilizes the element in a different context or with different functionality, the element is provided a different leading numeral representative of the figure number. The specific numerals assigned to the elements are provided solely to aid in the description and not meant to imply any limitations (structural or functional or otherwise) on the described embodiment.

It is understood that the use of specific component, device and/or parameter names (such as those of the executing utility/logic described herein) are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized. Specifically, as utilized herein, the term “crash” refers to a significant and targeted reduction in the price of a product/service.

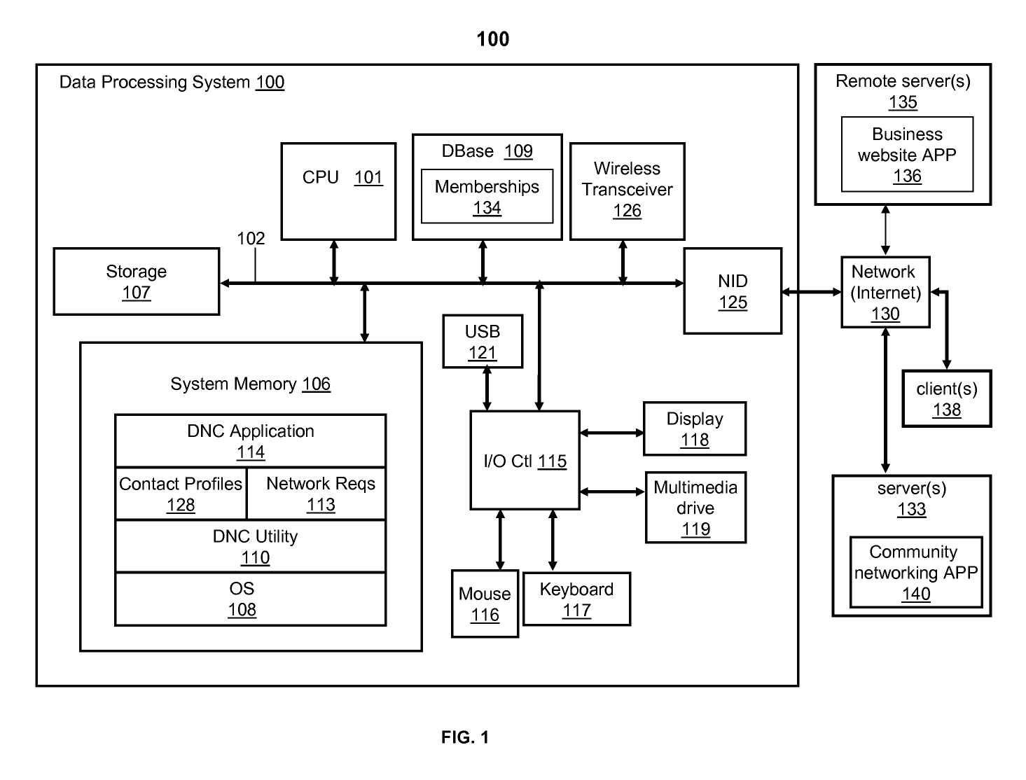

With reference now to the figures, and beginning with FIG. 1, there is depicted a block diagram representation of an example data processing system (DPS), as utilized within one embodiment. DPS may be a server, a personal computer, a portable device, such as a personal digital assistant (PDA), a smart phone, and/or other types of electronic devices that may generally be considered processing devices. As illustrated, DPS 100 comprises at least one processor or central processing unit (CPU) 101 connected to system memory 106 via system interconnect/bus 102. Also connected to system bus 102 is input/output (I/O) controller 115, which provides connectivity and control for input devices, of which pointing device (or mouse) 116 and keyboard 117 are illustrated. I/O controller 115 also provides connectivity and control for output devices, of which display 118 is illustrated. Additionally, a multimedia drive 119 (e.g., compact disk read/write (CDRW) or digital video disk (DVD) drive) and USB (universal serial bus) port 121 are illustrated, coupled to I/O controller 115. Multimedia drive 119 and USB port 121 enable insertion of a removable storage device (e.g., optical disk or “thumb” drive) on which data/instructions/code may be stored and/or from which data/instructions/code may be retrieved. DPS 100 also comprises storage 107, within/from which data/instructions/code may also be stored/retrieved. Database 109 is also connected to system bus 102 of DPS 100, within/from which business intelligence data and patrons' account information may also be stored/retrieved.

DPS 100 is also illustrated with wireless transceiver 126, which may receive and transmit signals from/to display monitors and receivers located in an environment that is within a wireless range of wireless transceiver 126. To further enable external network connection, DPS 100 also includes network interface component (NIC) 125, by which DPS 100 may connect to one or more access/external networks 130, of which the Internet is provided as one example. In this implementation, the Internet represents/is a worldwide collection of networks and gateways that utilize the Transmission Control Protocol/Internet Protocol (TCP/IP) suite of protocols to communicate with one another. NIC 125 may be configured to operate via wired or wireless connection to an access point of the network. Network 130 may be an external network such as the Internet or wide area network (WAN), or an internal network such as an Ethernet (local area network—LAN) or a Virtual Private Network (VPN). DPS 100 may also connect to one or more servers/clients 135 via network 130.

Connection to the external network 130 may be established with one or more servers 133, which may also provide data/instructions/code for execution on DPS 100, in one embodiment. In one embodiment, social/community networking site 140 is illustrated within server 133.

In addition to the above described hardware components of DPS 100, various features of the invention are completed/supported via software (or firmware) code or logic stored within memory 106 or other storage and executed by Processor 101. Thus, for example, illustrated within memory 106 are a number of software/firmware/logic components, including Internet/website based application 114, establishment website 128, Members account data 112 and device list 111. In one embodiment, members account data 112 are stored in DBase 109. In addition, memory 106 also includes network requests 113 and Dynamic Network Creation (DNC) logic/utility 110. In actual implementation, DNC logic 110 may be combined with application 114 to provide a single executable component, collectively providing the various functions of each individual component when the corresponding combined component is activated. For simplicity, DNC logic 110 is illustrated and described as a stand alone or separate logic/firmware component, which provides specific functions, as described below.

In one embodiment, server 133 represents a software deploying server, and DPS 100 communicates with the software deploying server (133) via network (e.g., Internet 130) using network interface device 125. Then, DNC utility 110 may be deployed from/on the network, via software deploying server 133. With this configuration, software deploying server performs all of the functions associated with the execution of DNC utility 110. Accordingly, DPS 100 is not required to utilize internal computing resources of DPS 100 to execute DNC utility 110.

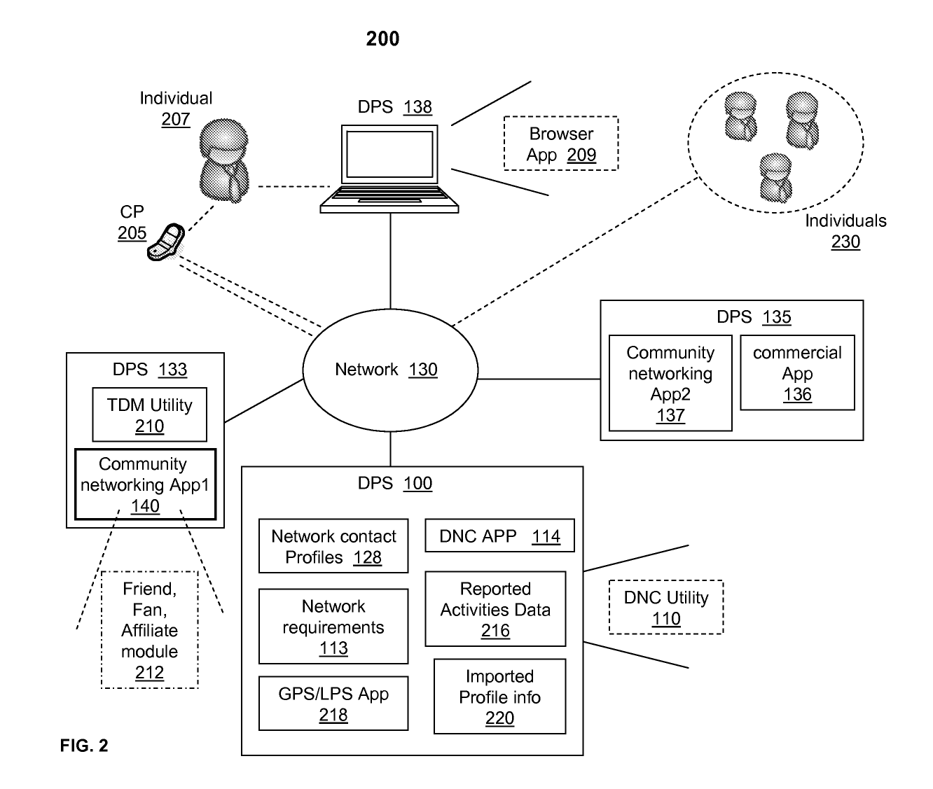

Certain of the functions supported and/or provided by DNC utility/logic 110 are implemented as processing logic (or code) executed by processor 101 and/or other device hardware, which processing logic completes the implementation of those function(s). Among the software code/instructions/logic provided by DNC logic 110, and which are specific to the invention, are: (a) logic for creating dynamic communication networks; (b) logic for developing a network contact profile; (c) logic for utilizing the network contact profile to automatically provide individuals with access to dynamic communication networks; (d) logic for developing a remote network contact profile to allow external application users to access dynamic communication networks; (e) logic for merging dynamic communication networks; and (f) logic for transferring messages/information between/across a dynamic communication network and an external application. According to the illustrative embodiment, when Processor 101 executes DNC logic 110, DPS 100 initiates a series of functional processes that enable the above functional features as well as additional features/functionality. These features/functionalities are described in greater detail below within the description of FIGS. 2-4.

Those of ordinary skill in the art will appreciate that the hardware components and basic configuration depicted in FIG. 1 may vary. The illustrative components within DPS 100 are not intended to be exhaustive, but rather are representative to highlight essential components that are utilized to implement the present invention. For example, other devices/components may be used in addition to or in place of the hardware depicted. The depicted example is not meant to imply architectural or other limitations with respect to the presently described embodiments and/or the general invention.

With reference now to FIG. 2, an example network of servers that are respectively configured to enable an individual to create/access dynamic communication networks, according to a network contact profile, is illustrated, according to one embodiment. Network 200 comprises DPS 100, which operates as first server, in addition to second server 133 and third server 135. In addition, Network 200 comprises DPS 138 and cellular telephone 205, which are electronic devices by which individual 207 connects to network 130. First server 100 comprises dynamic network creation application 114 and DNC utility 110. Server 100 further comprises network contact profile(s) 128, dynamic network definitions 113, GPS/LPS application 218, imported profile information 220 and reported/authenticated activities information 216. Second server 133 includes community networking application/engine 140 and DNC utility 210. Community networking application/engine 140 includes a corresponding community networking website and friend/fan/affiliate module 212. Third server 135 comprises commercial business application 136 and second community networking application 137. In one embodiment, DPS 100 and second server 133 are separate/independent entities. In another embodiment, DPS 100 and second server 133 are integrated within a single server. Furthermore, the illustrated components of DPS 100 and DPS 133 may be integrated with community networking application 140.

In Network 200, DNC utility 110 enables individual 207 to utilize browser application 209 on DPS 138 to access a corresponding member account provided by dynamic network configuration application 114. In addition, individual 207 has the option of accessing the member account by using cellular telephone (CP) 205. Individual 207 respectively accesses first community network application 140 and second community network application 137 on second server 133 and third server 135 via Network 130. Commercial application 136 on third server 135 generates authenticated activity/transaction report(s) 216 which is sent to DPS 100.

At first server 100, DNC utility 110 enables registered user/host/individual 207 to initiate the creation of a dynamic communication network (also referred to as a sub-network). DNC utility 110 enables individual 207 to specify the definition/requirements of the dynamic communication network according to the members who are intended to receive access to the dynamic communication networks. For example, DSN utility 110 may enable individual 207 on the Las Vegas Strip to create a sub-network that restricts the sub-network membership to registered guests who are staying within the same resort as the individual. Thus, for example, the individual confirms credentials and/or location as a guest in Caesar's Palace and communicates with others that are (a) currently located in Caesar's Palace and/or (b) a current guest of Caesar's Palace. In one embodiment, Caesar's Palace, for example, uses commercial application 136 to provide guest authentication (via reported activities data 216) to enable guests to be defined/authenticated as guests of Caesar's Palace. DSN utility 110 receives information about guests of Caesar's Palace based on established policies of Caesar's Palace. When individual 207 registers at Caesar's Palace, DSN utility 110 receives an information/report that authenticates the individual as a guest in Caesar's Palace resort. DNC utility 110 forwards the authenticated report to the network contact profile of the corresponding target individual(s). DNC utility 110 enables the target individual to determine via the network contact profile whether the authenticated report is utilized to provide access to the relevant sub-network(s). In addition, a target individual may permit only other authenticated residents to obtain sub-network communication access to him/her as a guest in Caesar's Palace. In one embodiment, a business entity, for example, Caesar's Palace, is registered as a subscriber to DNC application 114 to enable Caesar Palace to use a subscriber account (for Caesar's Palace) to define the terms of access and registration with associated dynamic communication networks. In one embodiment, DNC application 114 provides Caesar's Palace an exclusive right as a host creator of a dynamic communication network which requires authentication by Caesar's Palace for individuals to gain network access. For example, Caesar's palace may allow current and/or past guests (who are members of DNC application 114) to communicate with each other once registration is completed (i.e., with payment received) and/or the guest is checked into the Caesar's Palace resort. Caesar's Palace may also create an exclusive network for those guests in the penthouse suites via DNC application 114.

In one embodiment, an individual is able to trigger authenticated self-reporting based on the use of electronic receipts. In one embodiment, DNC utility 110 processes a suitably formatted electronic receipt that provides proof of an activity/transaction to verify/confirm that an individual did participate in an activity/transaction that is indicated by the electronic receipt. Thus, DNC utility 110 authenticates the individual's participation in the activity and allows the individual apply this authentication in order to access selected dynamic communication networks. In one embodiment, DNC utility 110 is configured to provide manual authentication. For example, DNC utility 110 may allow individuals to join a dynamic communication network configured as a millionaire's club in a particular region based on visual inspection of bank documentation and/or other supporting documents of an individual interested in accessing the network.

In one embodiment, when an individual participates in an activity or transaction via an external business entity/commercial application, the business entity may ask or may, otherwise, determine whether the individual is a member of the social network application. In response to the individual being a member of the social network application. The business entity may further determine whether the individual (wishes to permit and/or) permits an initiation of a transfer of authenticated information about the activity or transaction to the social network application (for the purpose of having/recording a transaction report and/or enable potential access to a communication network). In response to a determination that the individual permits the initiation of the transfer, the business entity initiates the transfer according to receipt of proper authorization from the individual. DNC utility 110 may accept/configure a card as an instrument for authorization and/or to enable the transfer of information to member's account after the card is swiped/read.

DNC utility 110 enables a registered/active user on a remote/external application to access dynamic communication networks, according to the remote network contact profile. DNC utility 110 configures the external application (e.g., second community networking application 137) to provide the registered user with a remote network contact profile for sub-network communication. In one embodiment, a remote module of the external application provides a link to the relevant dynamic communication networks. The remote module identifies a remote network contact profile derived from an individual's resident profile information on the external application. The corresponding individual may further develop the remote network contact profile to provide information that may not be included within the resident profile information of the external application which information may be intended for use via DNC application 114. In one embodiment, the remote network contact profile has substantially identical features/components of the network contact profile on the internal/local platform application (e.g., application 114). In one embodiment, remote modules on external applications provide (universal) access to individuals registered on various applications. Furthermore, the remote module on the external application determines the relevant member pool on the corresponding external application based on the network (membership) specifications/requirements.

In one embodiment, DNC utility 110 adapts one or more resources, for example, a message window, to allow the individual on the remote platform to communicate with members of sub-networks. In one embodiment, DNC utility 110 enables a first individual to publish messages and/or selected message excerpts to external applications. In addition, DNC utility 110 enables an individual to export ID information from the first platform to the second platform.

DNC utility 110 enables members (e.g., individuals 230) to have communication/conversation (in a sub-network) hosted/staged on multiple sub-networks/platforms. In one embodiment, DNC utility 110 provides communication via one or more of: (a) Internet Protocol (IP) telephony; and (b) public switched telephone network (PSTN). In other words, DNC utility 110 enables broadcast of message communication activity of sub-network on multiple sub-networks/platforms. DNC utility 110 enables individual 207 and/or individuals 230 to respectively choose a particular ID when staging conversations within a sub-network on additional platforms. For example, within a single sub-network, individual 207 may be observed by members of first community networking application 140 via a first corresponding ID. However, individual 207 may be (at the same time) observed by members of second community networking application 137 via a second corresponding ID.

DNC utility 110 enables an individual to merge two or more sub-networks. For example, a host/individual engaged a first sub-network discussion may wish to receive input from one or more persons having a particular expertise. DNC utility 110 enables the individual to initiate another/second sub-network to have initial discussions with members that have particular qualifications, according to the network contact profile. DNC utility 110 enables the host/individual to merge the second sub-network with the first sub-network. In one embodiment, DNC utility 110 automatically sends notifications to participants/members in the first sub-network and the second sub-network and select whether to allow them to be affiliated with the other network.

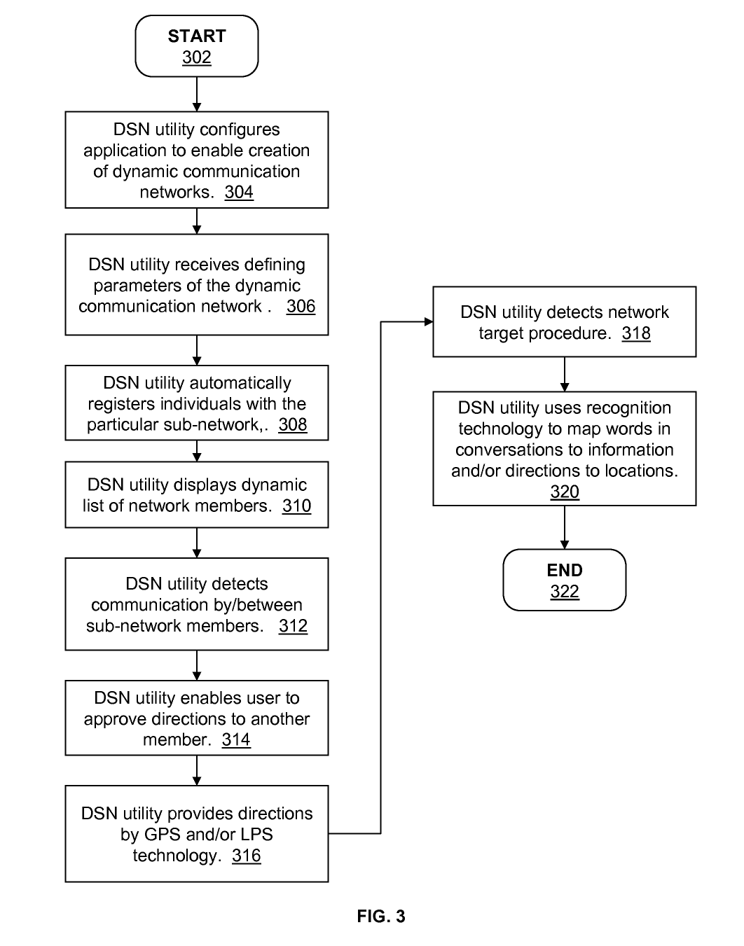

FIG. 3 is a flow chart illustrating the process of creating dynamic communication networks, developing a network contact profile and utilizing the network contact profile [or imported/pseudo network contact profile] to automatically provide individuals with access to dynamic communication networks, according to one embodiment. The process of FIG. 3 begins at initiator block 302 and proceeds to block 304, at which the dynamic network configuration (DNC) utility 110 configures a corresponding application, for example application 114/TingleMingle®, (to provide features of DNC utility 110) to enable an individual to create a dynamic communication network. In addition, DNC utility 110 enables individuals to register as users/members of the application. In addition, DNC utility 110 provides the capability for individuals/registered users to develop and update a network contact profile. Using the network contact profile, DNC utility 110 enables the individual to select the personal data that is used to determine whether the individual fulfills the access requirements/definition/characteristics of a particular network/sub-network. The personal data includes transaction/activity reports/information, particular experience, credentials, gender, etc. DNC utility 110 enables the individual to map accounts/IDs from other applications/platforms to the individual via the network contact profile. DNC utility 110 enables individuals to define/determine (via the network contact profile) locations/time/schedule for which the individual accepts (automatic) access to certain dynamic communication networks. DNC utility 110 uses data within the network contact profile to determine whether automatic or semi-automatic network access occurs. In one embodiment, a potential member (i.e., that satisfies sub-network requirements) may choose to receive a notification before permitting other members full sub-network access to the potential member. The potential member is able to inspect current members and/or previous messages before accepting full sub-network membership. In one embodiment, DNC utility 110 enables a member to accept inclusion within a group/sub-network to communicate with specific members, according to preset configurations pertaining to member and peer characteristics.

At block 306, DSN utility 110 receives from the host/individual information pertaining to the (access) definition/requirements of the dynamic communication sub-network. In particular, DSN utility 110 enables the individual to define the sub-network by one or more of: (a) the characteristics of individual members; (b) location of members; (c) affiliation; (d) credentials; (e) activities; and (f) interests. For example, the individual may be an authenticated registrant/participant at a convention who wishes to communicate with any other authenticated convention participants who may be open to communication. DNC utility 110 may confirm that individuals are authenticated participants of the convention based upon an activity/transaction report received from the convention management via an external application.

In one embodiment, DNC utility 110 enables individuals to satisfy authentication requirements based on a preset combination of two or more particular sets of information. For example, a person may also be authenticated as an authorized guest in a hotel by a GPS/LPS reading/report via a cell phone confirming a person's location/presence in a hotel room. In addition, the person seeking authentication may be required to electronically confirm via acceptance of a predetermined statement that he/she is a guest or a visitor of an authorized guest in the hotel. The sub-network host/individual may further define the network/sub-network by selecting the convention participants who are stationed (e.g., with display booths) on the second floor of the convention hall. The authenticated participants may be members of various community networking websites. However, these participants may either be previously assembled or may not have been previously assembled within a single pre-established network or group. In one embodiment, DSN utility 110 configures a sub-network to selectively enable communication (i.e., voice, SMS, text, video, data/file transmission, etc) between sub-network members. In one embodiment, DSN utility 110 enables individuals to select network/connection configurations that enable individuals to automatically accept/receive memberships/access to networks and/or network members based on a particular/select set of characteristics/interests. In particular, an individual may choose a select set of characteristics which may include one or more of: (a) the characteristics of the individual; (b) location of the individual; (c) affiliation; (d) credentials; (e) activities; and (f) interests. When the defining parameters of the sub-network match information from the pre-selected set of characteristics of the individual, DSN utility 110 grants sub-network membership/access to the individual. Similarly, the individual may define particular requirements for the host and/or members of a particular sub-network that must be satisfied before the individual accepts membership into the sub-network. In one embodiment, DSN utility 110 enables the sub-network host to transmit broadcast/unicast messages to all members. DSN utility 110 enables members to send multi-cast/broadcast/unicast messages to a plurality of members, according to the particular requirements defined by the respective member for the host and/or members of a particular sub-network.

At block 308, DSN utility 110 automatically registers individuals with the particular sub-network, according to the network definition. In one embodiment, DNC utility 110 enables the individual to perform “universal matching” to communicate with registered users of applications on various platforms based on matching characteristics. In one embodiment, a universal matching sub-network configuration enables individuals registered on various external platforms based on basic information provided and/or group affiliations within applications on various platforms to access the corresponding sub-network. In one embodiment, when matches on external platforms are found, DNC utility 110 receives indication of the network affiliation(s) of targets, and DNC utility 110 sends invitations to targets for targets to access the sub-network. Thus, DSN utility 110 utilizes the definition of the sub-network to obtain a potential pool of sub-network members from collective subscribing networks (i.e., the universal network) and network members. For example, a single pool may comprise members from various community network websites and/or members with multiple website memberships corresponding to the various community network websites.

DSN utility 110 determines whether individuals within the potential pool are automatically registered, according to user configurations. In one embodiment, DSN utility 110 may alert potential network members with notifications to indicate when other members become active, which notifications may further encourage semi-automatic registration by potential network members. DSN utility 110 displays a list of active/registered sub-network members, as shown at block 310. DSN utility 110 detects the initiation of communication between sub-network members, as shown at block 312. In one embodiment, DSN utility 110 provides multicast/broadcast/unicast communication between individuals. At block 314, DSN utility 110 receives a unanimous consent/agreement to initiate the exchange of directions between individuals. At block 316, DSN utility 110 provides directions from a first individual to a second individual. In one embodiment, DSN utility 110 provides directions from a first individual to a second individual via GPS and/or LPS technology (which may be facilitated by GPS/LPS application 218). In one embodiment, DSN utility 110 provides a seamless combination of GPS and LPS technology to produce a set of directions between individuals (or to another selected destination). In addition, DSN utility 110 provides information about separation distance/time based on walking/driving. In one embodiment, DSN utility 110 dynamically updates user directions and time/distance/separation, according to a dynamic GPS/LPS technology which provides directions between targets which may both be moving. In another embodiment, a target may send GPS/LPS information to the individual to set an appointment for a subsequent meeting at a particular location.

At block 318, DSN utility 110 detects the initiation of a targeted sub-network by using a sub-network scanning/targeting procedure to attempt communication with particular individuals. For example, the individual may wish to communicate with someone that is located within eye-sight/point of view of the individual. DSN utility 110 enables the individual to provide an estimate of the target's location relative to the individual to determine the individual's user identity. DSN utility 110 may use several location estimation mechanisms including selecting/identifying the target's position/location on a GPS/LPS map showing landmarks/reference points relative to a particular location/point of view. In one embodiment, identification of the target via a cell phone camera image may also be utilized to provide an estimate of the target's location. Based on the location estimate and/or other obvious characteristics, DSN utility 110 determines whether the target is identifiable (i.e., as someone who is willing to communicate with the searching individual and/or others) on a particular pre-established sub-network. For example, DSN utility 110 enables the individual to search for a target with the estimated location who is also defined by a respective gender (i.e., male or female). The individual may access a pre-established network to communicate with the identified target according to the target's established sub-network configurations/permissions. Additionally, DSN utility 110 may allow the individual to create a sub-network (for two) to enable communication with the particular target. DSN utility 110 enables sub-network communication between the individual and the target, according to the configured settings of the target user. In one embodiment, as another location estimation mechanism, DSN utility 110 provides the user with a GPS enabled compass display by which the user is able to indicate the direction in which the target is observed/located. In addition, DSN utility 110 prompts the user to provide an estimate of the distance between the individual and the target.

At block 320, DSN utility 110 uses voice recognition technology to map/link words and phrases in user conversations (i.e., communication messages) to information about topics/nearby locations, based on users interests. In one embodiment, DSN utility 110 provide users with directions to locations of interest based on communication messages. For example, DSN utility 110 may provide directions to the closest location to a particular user as a meeting place based on contents of conversations/profile information. If food/eating is discussed, DSN utility 110 may provide information to the nearest pizza place if an individual's profile info reveals pizza as one of the individual's favorite foods. The process ends at block 322.

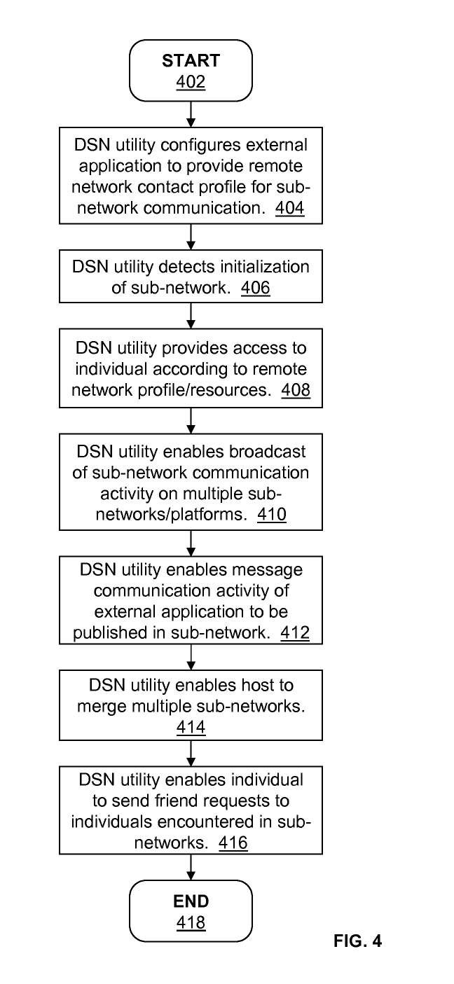

FIG. 4 is a flow chart illustrating the process of creating/utilizing a remote network contact profile to access dynamic communication networks, merging dynamic communication networks, and transferring messages/information between a dynamic communication network and an external application, according to one embodiment. The process of FIG. 4 begins at initiator block 402 and proceeds to block 404, at which DNC utility 110 configures external application to provide remote network contact profile for sub-network communication. Thus, DNC utility 110 enables an active user on an external application (e.g., Facebook®) to access dynamic communication networks (also referred to as sub-networks), according to the remote network contact profile on the external application. In one embodiment, a remote module (associated with DNC application 114) is integrated within the external application and provides a link to the relevant dynamic communication networks. The remote module identifies a remote network contact profile derived from an individual's resident profile information on the external application. For example, the remote module allows the individual on Facebook® to select/identify the relevant information from among the resident profile information on Facebook® for providing access to dynamic communication networks. The corresponding individual may further develop the remote network contact profile to provide information that may not be contained within the resident profile information of the external application. In one embodiment, the remote network contact profile has the substantially identical features/components of the network contact profile on the internal platform application (e.g., application 114/TingleMingle®). In one embodiment, the module on an external application enables (universal) access to individuals registered on various applications. Furthermore, the remote module on the external application determines the relevant member pool on the corresponding external application based on the network (membership) specifications/requirements.

At block 406, DNC utility 110 detects the initialization of a dynamic communication network. At block 408, DNC utility 110 provides access to individual on the remote platform, according to the remote network profile. In one embodiment, DNC utility 110 adapts one or more resources, for example, a message window, to allow the individual on the remote platform/application to communicate with members of sub-networks.

At block 410, DNC utility 110 utilizes the first/internal application (e.g., application 114) and/or the external application/remote module to enable an individual with a first account on the same/first platform as DNC utility 110 to report/publish/broadcast activities that are initiated on the first platform to a second/external platform. In one embodiment, DNC utility 110 enables the individual to publish messages and/or selected message excerpts to external applications. In addition, DNC utility 110 enables an individual to export ID information from the first platform to the second platform. For example, an individual who is identified by “professor76” on application 114/TingleMingle® may utilize his “professor76” ID from TingleMingle® when active Facebook® members are participating/communicating within a sub-network that is hosted/staged on the Facebook® platform in addition to being hosted on the home platform/application 114/TingleMingle®. In addition, DNC utility 110 enables the individual to indicate multiple ID's (with links to the individual's respective homepages) corresponding to the respective platforms.

DNC utility 110 enables members to have a conversation (in a sub-network) hosted/staged on multiple sub-networks/platforms. In other words, DNC utility 110 enables broadcast of message communication activity of sub-network on multiple sub-networks/platforms. Video streams, images and/files pertaining to conversations initiated on a first platform may also be accessed/displayed via other sub-networks/platforms, according to the permissions of owners/authors of the respective data/content. DNC utility 110 enables individuals to respectively choose a particular ID when conversations/messages taking place within a particular sub-network (e.g., on application 114) are staged on additional platforms (e.g., on Facebook®). In one embodiment, DNC utility 110 enables a first individual to invite/request other individuals participating in a conversation in a sub-network to allow/permit the conversation to be displayed in real-time or via a broadcast delay within a particular application. DNC utility 110 enables a participant in a conversation/discussion on a first sub-network to invite individuals with certain characteristics to join a discussion in a second sub-network.

At block 412, DNC utility 110 enables message communication activity of external application to be published in sub-network. For example, DNC utility 110 enables an individual that uses a micro-blogging application (e.g., Twitter®) on a second/external platform to utilize ID information corresponding to the micro-blogging application as identification for the individual in a sub-network on the first platform. Thus, DNC utility 110 enables the individual to be identified via the ID from a second application/platform while communicating with specific viewers/listeners/subscribers/participants/targets on the first platform, according to the network contact profile.

At block 414, DNC utility 110 enables an individual to merge two or more sub-networks. For example, a host/individual engaged in a first sub-network discussion may wish to receive input from one or more persons having a particular expertise. DNC utility 110 enables the individual to initiate another/second sub-network to have initial discussions with members that have particular qualifications, according to the network contact profile. DNC utility 110 enables the host/individual to merge the second sub-network with the first sub-network. In one embodiment, DNC utility 110 automatically sends notifications to participants/members in the first sub-network and the second sub-network.

At block 416, DNC utility 110 enables viewers/listeners to select favorite participants to create links to selected participants' respective pages. DNC utility 110 enables participants to export group of new/interesting friends encountered within sub-networks to other/external platform(s). DNC utility 110 allows individuals to meet other individuals in a first setting (e.g., a social setting via a particular application) and invite these other individuals to share experiences in other settings (e.g., a business and/or academic setting via another application). By exporting communicating friends within a particular sub-network, DNC utility 110 enables participants to automatically send friend requests to each person individually. The process ends at block 418.

The illustrated and described embodiments provide, in a data processing system, a method, a system and a computer program product that enables an individual to efficiently create dynamic communication networks to communicate with members that have particular interests and experience, according to a network contact profile. A dynamic network creation (DNC) logic/utility executes on a data processing system and enables an individual to spontaneously create a dynamic network defined by one or more of: (a) location of members; (b) particular affiliation of members; (c) experience of members; (d) authenticated credentials; and (e) other characteristics. The DNC utility enables the user to create a network contact profile or import existing profile information from a particular social networking application to the DNC system application. Thus, the DNC system allows individuals to create a network that may comprise members identified by various network affiliations. Thus, the DNC utility enables cross platform communication. The DNC system uses a target communication mechanism to enable a user to initiate a communication with a particular individual or a group of individuals. The DNC employs dynamic and intelligent GPS/LPS to provide directions between individuals in an established network

In the flow charts above, certain processes of the methods are combined, performed simultaneously or in a different order, or perhaps omitted, without deviating from the spirit and scope of the invention. Thus, while the method processes are described and illustrated in a particular sequence, use of a specific sequence of processes is not meant to imply any limitations on the invention. Changes may be made with regards to the sequence of processes without departing from the spirit or scope of the present invention. Use of a particular sequence is therefore, not to be taken in a limiting sense, and the scope of the present invention extends to the appended claims and equivalents thereof.

As will be appreciated by one skilled in the art, the present invention may be embodied as a method, system, and/or logic. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” “logic”, or “system.” Furthermore, the present invention may take the form of a computer program product on a computer-usable storage medium having computer-usable program code embodied in or on the medium.

As will be further appreciated, the processes in embodiments of the present invention may be implemented using any combination of software, firmware, microcode, or hardware. As a preparatory step to practicing the invention in software, the programming code (whether software or firmware) will typically be stored in one or more machine readable storage mediums such as fixed (hard) drives, diskettes, magnetic disks, optical disks, magnetic tape, semiconductor memories such as RAMs, ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The medium may be electronic, magnetic, optical, electromagnetic, infrared, or semiconductor system (or apparatus or device) or a propagation medium. Further, the medium may be any apparatus that may contain, store, communicate, propagate, or transport the program for use by or in connection with the execution system, apparatus, or device. The methods of the invention may be practiced by combining one or more machine-readable storage devices containing the code according to the described embodiment(s) with appropriate processing hardware to execute the code contained therein. An apparatus for practicing the invention could be one or more processing devices and storage systems containing or having network access (via servers) to program(s) coded in accordance with the invention. In general, the term computer, computer system, or data processing system can be broadly defined to encompass any device having a processor (or processing unit) which executes instructions/code from a memory medium.

Thus, it is important that while an illustrative embodiment of the present invention is described in the context of a fully functional wireless communication system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a data processing system, a method comprising:
registering an individual as a member with a member account on a social network application;
enabling said member to create/configure dynamic communication networks via said social network application;
registering a commercial application to register as a subscriber to the social network application;
configuring a commercial application or other external application to forward authenticated information about an activity or transaction of a member to the social network application;
detecting receipt of authenticated information about an activity or transaction of a member;
upon receipt of authenticated information about an activity or transaction, automatically determining whether the information fulfills requirements of one or more dynamic communication networks (DCNs);
registering said individual with the dynamic communication network, according to registration requirements of DCNs; and
in response to said registering, providing said individual with communication access to other members of the DCN.

2. The method of claim 1, further comprising:
categorizing activities outlined in the transaction reports/schedules;
enabling the user to select a subset of the information from said transaction reports to be displayed to contacts/friends in the social media application;
displaying the subset of information from said transaction reports to contacts/friends in the social media application; and
enabling the user to provide supplemental information about transactions reported via the member account.
